(19) United States
(12) Patent Application Publication
(10) Pub. No.: US 2011/0055447 A1
(43) Pub. Date: Mar. 3, 2011

(54) DOCKING SYSTEM FOR MEDICAL DIAGNOSTIC SCANNING USING A HANDHELD DEVICE

(75) Inventor: Glenn Costa, Joondanna (AU)

(73) Assignee: SIGNOSTICS LIMITED, Torrensville, SA (AU)

(21) Appl. No.: 12/990,783

(22) PCT Filed: May 5, 2009
(86) PCT No.: PCT/AU2009/000559

§ 371 Date: Nov. 3, 2010

(30) Foreign Application Priority Data
May 7, 2008 (AU) 2008902223

(51) Int. Cl. G06F 13/00

(52) U.S. Cl. 710/304

(57) ABSTRACT

A docking system Including a clocking assembly which is able to surround and at least partially protect a handheld device such as a PDA or a smartphone, on In particular an IPhoπe, as made by Apple Inq, whilst providing means for connection of a probe unit to the handheld device. The probe unit has a data acquisition function.

### TECHNICAL FIELD

The present invention relates to a docking system adapted for use with a handheld data processing device, the docking system bringing additional functionality to the device by including a data gathering unit, The data gathering unit may be a medical diagnostic probe. In particular it relates to a system with ultrasound capability.

### BACKGROUND ART

Ultrasound imaging is widely used as a safe, non-invasive method of medical imaging. Ultrasound energy is transmitted into the body of a patient and the reflected echoes from a particular direction, called scanlines, are received and processed to produce an image which can be interpreted to show internal features of the body.

Modern, high end ultrasound imaging systems include electronic beam steering transducers. These consist of a number of electronic crystals where the transmitting pulse can be delayed in sequence to each crystal and effect an electronic means to steer the ultrasound beam. Modern designs sometimes use a thousand crystals or more.

However, the cost of producing transducers with arrays of crystals is high. There is also a high cost in providing the control and processing circuitry, with a separate channel being required for each crystal. The transducers are usually manually manufactured, with the channels requiring excellent channel to channel matching and low cross-talk. The power consumption for electronic systems is also high, and is generally proportional to the number of channels being simultaneously operational,

Those high cost, high power consumption devices are unsuitable for broad point-of-care application outside of specialist sonography facilities. In particular, these systems are unsuitable for application to hand-held devices. Providing useful images from simpler transducer arrangements, which are suitable for hand-held use, within the prior art is difficult in part because of the difficulty of providing a uniformly distributed set of scanlines in a single scan plane.

A lower cost solution has been disclosed in U.S. patent application Ser. No. 12/092,590, which is hereby incorporated by reference. This returns to the concept of the single scanline as used by the static mode scanners, but with the movement information provided by an inertial sensor.

The personal digital assistant (PDA) has developed from the innovative but commercially unsuccessful Newton, released by Apple, Inc to a hand held processor with significant processing power, with strong market penetration,

The mobile cellular telephone has developed from a large, expensive power hungry device to a small, ubiquitous communications tool, with significant computer processing power. These devices can be used for days in many cases before needing to be recharged.

The combination of the features of a PDA with those of a cellular telephone has led to the creation of the smartphone. Smartphones are carried by large numbers of people. Those devices have a display, they provide a user interface, and they have significant processing power. They are carried by large number of people. There is a high level of acceptance of carrying these devices by a user at almost all times.

The PDA and the smartphone have increasingly included functionality allowing third party software to be run on the included processors. It is no longer necessary for this add on software to be related to the primary purpose of the PDA or smartphone,

### DISCLOSURE OP THE INVENTION

A portable, medical probe unit and widely available portable processing capability may be combined to provide a portable medical diagnostic instrument at relatively low cost. However, a PDA or smartphone is not designed with the robustness required of a portable medical diagnostic unit.

In one form of this invention there is proposed a docking system including a docking assembly which is able to surround and at least partially protect a handheld device such as a PDA or a smartphone, on in particular an iPhone, as made by Apple Inc, whilst providing means for connection of a probe unit to the handheld device. The probe unit has a data acquisition function.

In general, the docking system is adapted for use with a commercially available handheld data processing device of a type including a display, a processor and an I/O port, The system includes a connection means to connect to a port which is a part of the handheld device. There is a medical diagnostic scan probe unit able to collect medical diagnostic data and to transmit said data to the handheld processing device via the connection means. A software application is run on the processor which will process said data and display the information resulting from the processing of the data The system is able to accept user input via the handheld device, and to use such user input to control functions of the probe unit.

The dock assembly will at least partially surround the handheld device to support and protect the device.

In preference, the connection means is a physical connector of a type supplied by the PDA or smartphone. The connection may be a USB connection. In general, the connections provided for communication ports on hand held devices are not physically robust nor resistant to being accidentally disconnected,

In preference the dock assembly serves to keep the connector in place and protected.

In preference the connection means is a physical connector. It may be a fixed, permanent connection, or it may be a removable. preferably pluggable connection.

In the alternative, the connection means may be a wireless communication channel.

In preference, the dock assembly has at least two portions which are adapted to mate around the handheld device to support and protect the handheld device. The function of the dock assembly is to provide a platform for any additional controls or battery, while providing physical protection for the handheld device.

In the alternative, the dock assembly includes a body portion which is a single piece and at least part of the dock body is constructed of a deformable material able to deform around the handheld device to secure the handheld device within the dock body.

This assembly may be of rubber or a rubber like material which is able to stretch to accommodate the insertion of the handheld device and then to return to shape to grip the device. This has the advantage that the dock body, being one piece, may be more weatherproof.

A further shortcoming of a standard PDA or srnartphone is limited battery capecity. Battery capacity is typically barely sufficient to perform the standard device functions for a useful period. The additional battery demand of the diagnostic probe may be unsupportable.

In preference, the docking assembly. includes a battery, which may contribute to the physical robustness of the dock assembly, and hence to the protection of the hand held device.

### BRIEF DESCRIPTION OF THE DRAWINGS

FIG. 1 is a view of a docking assembly according to a preferred embodiment of the present invention.

FIG. 2 is a partially exploded view of the embodiment of FIG. 1, showing the hand held device separated from the dock.

FIG. 3 is a further partially exploded view of the embodiment of FIG. 1 , showing the connectors between the dock and the hand held device.

FIG. 4 shows a further embodiment of the dock.

FIG. 5 shows a block diagram of an embodiment of the invention.

FIG. 6 shows a block diagram of a further embodiment of the invention.

### BEST MODE FOR CARRYING OUT THE INVENTION

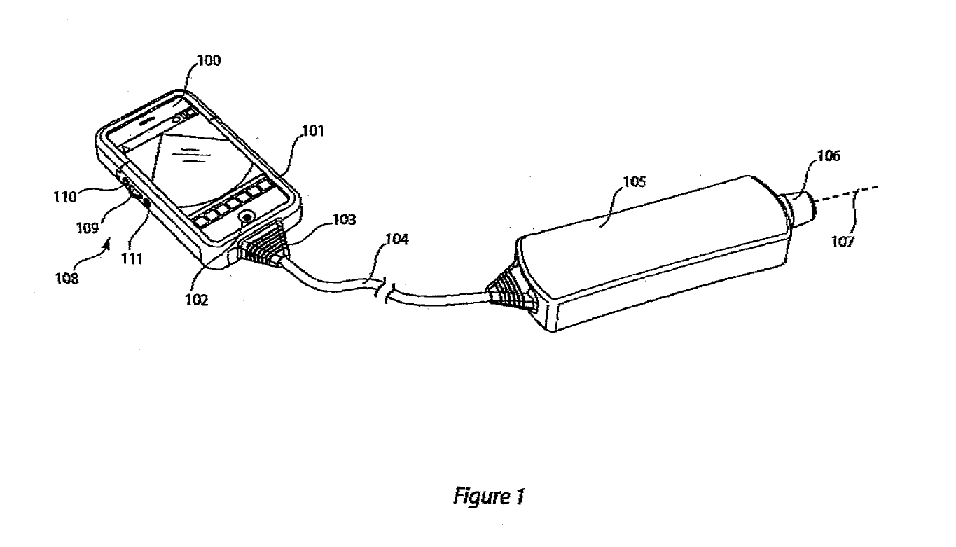

Now referring to the illustrations, and in particular to FIG. 1, there is provided a commercially available hand held device of a type having a display and means for user input. The hand held device has a capability to provide a data processing function, and is able to accept programming for applications beyond the use for which it is primarily made.

The hand held device may be a smartphone or a PDA (Personal Digital Assistant), or any other suitable device.

In the embodiment of FIG. 1, the hand held device is a smartphone, in particular an iPhone 100, being a smartphone device manufactured by Apple, Inc.

The iPhone 100 is releasably held within a docking assembly 101. The docking assembly encloses the periphery of the iPhone, protecting it against physical shocks.

Medical devices of a hand held size, intended for use as diagnostic tools in, such places as emergency departments, need to be physically rugged. In general, commercially available devices such as the iPhone are insufficiently rugged to withstand the dropping and knocking which will be experienced by a diagnostic device in such circumstances.

The docking assembly serves to at least partially protect the iPhone, making it suitable for use in hostile environments where it would not otherwise be useful,

The iPhone includes as standard a connector enabling it to be connected to external devices, to a docking cradle and to a battery charging facility.

The docking assembly includes a connector 102 which is able to make connection with this connector. The standard connector on hand held devices such as the iPhone are designed for short term connection in a static environment. The connectors are designed to be easy to plug and unplug. They are not intended to be robust against unintended removal, nor are such connectors designed to resist any but minor flexing stress whilst in use. Such connectors are unsuitable for the connection of a diagnostic probe to the hand held device.

The connector 102 is integrated into the body of the dock 101, making a robust connection where it is very difficult for the connected parts to become separated inadvertently.

In a further embodiment, the connector 102 is absent, and the data connection from the docking system to the hand held device is provided by wireless connection. Examples of possible wireless connections are Bluetooth (IEEE 802.15.x) or Wi-Fi (IEEE 802.11 a/b/g/n).

A probe connector 103 provides a connection to a cord 104 which is connected to a probe unit 105.

In other embodiments, data connection to the probe unit may be provided by a wireless connection. Examples, of possible wireless connections are Bluetooth (IEEE 802.15.x) or Wi-Fi (IEEE 802.11 a/b/g/n).

The probe unit includes circuitry, which may include one or more processors, which is adapted to provide medical diagnostic information. In the illustrated embodiment, the probe unit provides an ultrasound scan capability.

The probe unit 105 includes an ultrasonic transducer 106 adapted to transmit pulsed ultrasonic signals into a target body and to receive returned echoes from the target body.

In this embodiment, the transducer is adapted to transmit and receive in only a single direction at a fixed orientation to the probe unit, producing data for a single scanline 107.

The probe unit further includes an orientation sensor capable of sensing orientation or relative orientation about one or more axes of the probe unit. Thus, in general, the sensor is able to sense rotation about any or all of the axes of the probe unit.

The sensor may be implemented in any convenient form. In an embodiment the sensor consists of three orthogonally mounted gyroscopes. In further embodiments the sensor may consist of two gyroscopes, which would provide information about rotation about only two axes, or a single gyroscope providing information about rotation about only a single axis.

It would also be possible to implement the sensor with one, two or three accelerometers.

The docking assembly also includes a supplementary user interface 108. This allows for additional or more convenient control to that provided by the user interface of the iPhone.

In the illustrated embodiment the supplementary user interface comprises a scrollwheel 109 and two push buttons 110, 111. These controls provide the functions of moving a cursor and selection of a menu option in a user interface. It will be obvious to one skilled in the art that any suitable user input elements could be used including for example a capacitive scroll bar, within the restrictions of size imposed by the need to fit within the dock but still be accessible to a user.

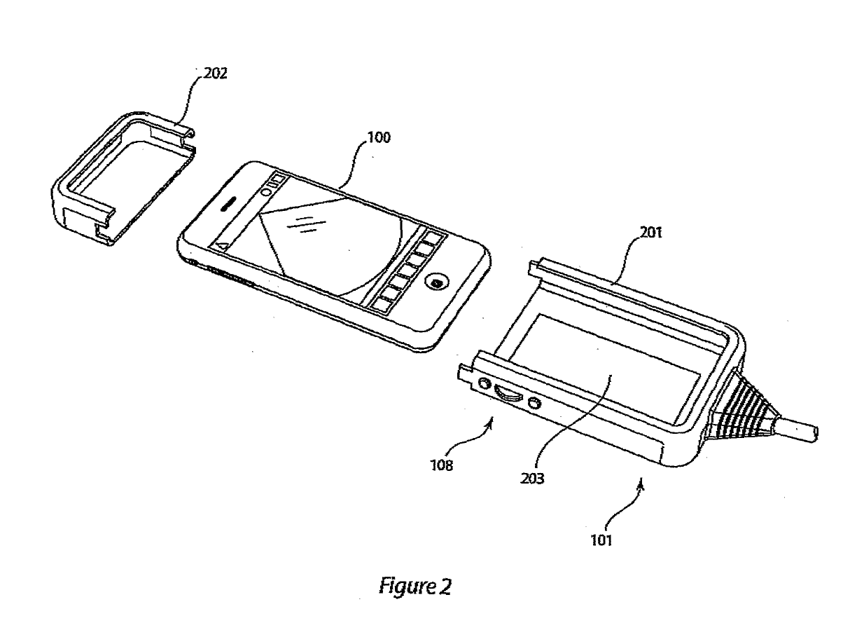

FIG. 2 shows a partially exploded view of the docking assembly. The clinking assembly is comprised of two major sections, the primary dock 201 and the secondary dock 202, The hand held device 100 is fitted into the primary dock 201, and is secured in place by mating the secondary dock 202 with the primary dock 201. In the illustrated embodiment, the primary and secondary dock are able to be completely separated, but in other embodiments they may be connected by a hinge or clip.

The primary dock includes a secondary battery 203. The battery 203 may be a fixed part of the dock or it may be removable.

In an embodiment the battery provides rigidity to the docking assembly and forms part of the docking assembly serving to further protect the iPhone. In other embodiments, the docking assembly may fully enclose the battery, with the battery not contributing to the physical protection function of the docking assembly.

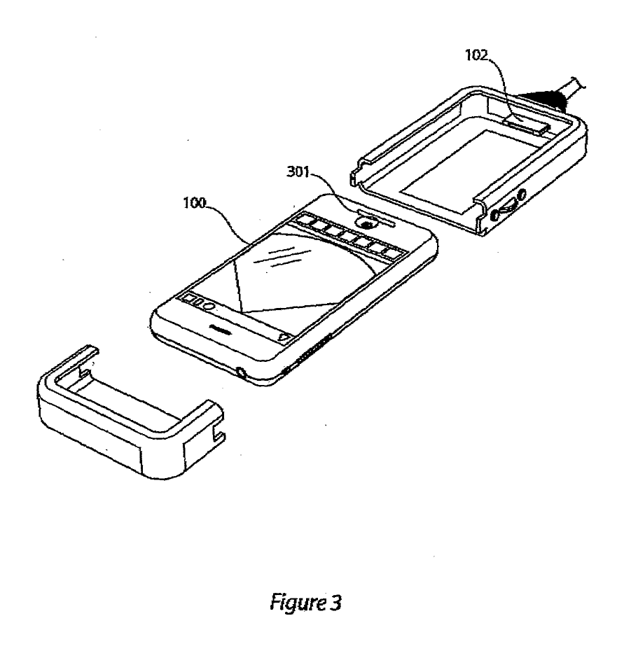

FIG. 3 shows a further view of the partially exploded dock assembly. It can be seen that the dock incorporates a connector 102, on the inside of the dock. This is adapted to connect to the standard connector 301 provided on the hand held device 100. This connection provides a data connection between the hand held device and dock and the probe attached to the dock. The physical and electrical connection characteristics of the connection are determined by the connection standard defined by the manufacturer of the hand held device. No particular level of resistance to disconnection or physical robustness is required for the connector, since it is internal to the dock.

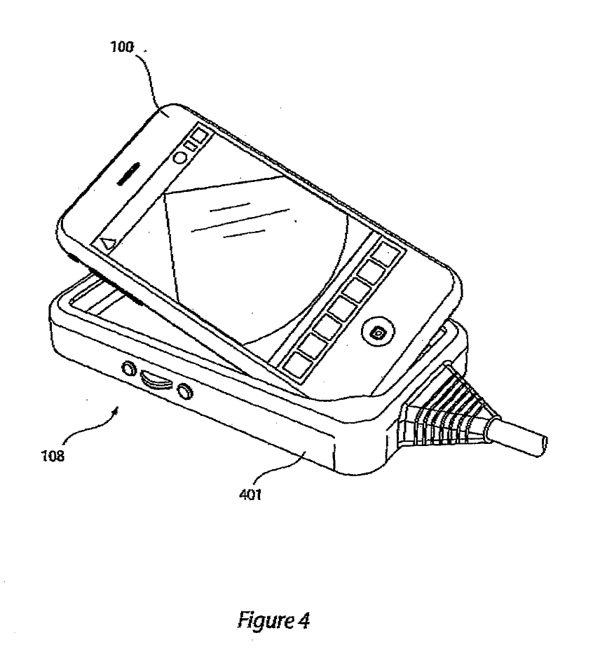

FIG. 4 illustrates a further embodiment. In this embodiment, the dock assembly is a single piece 401. This single piece 401 is at least partly deformable. It is at least partly formed of a deformable material such as rubber or neoprene. As shown in FIG. 4, the hand held device 100 is able to be inserted into the dock structure 401 which is able to deform to partially surround and grip the hand held device 100. The additional controls 108 are provided as part of the dock as for the embodiment of FIG. 1.

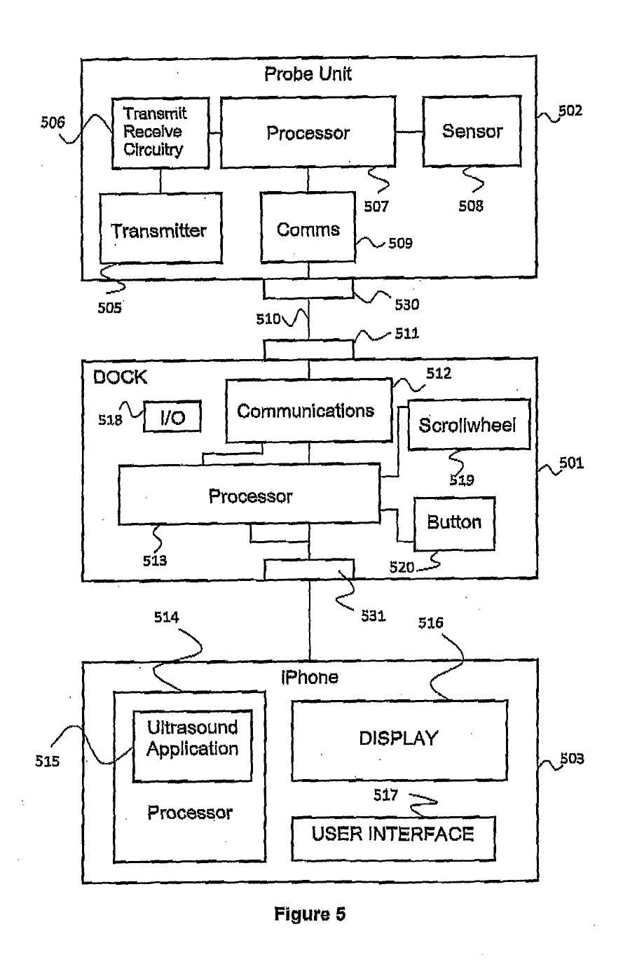

FIG. 5 shows a functional block diagram of an embodiment of the invention. There is provided a probe unit 502 which may have one or more medical diagnostic functions. These functions may include, without limitation, those of an otoscope, an endoscope, blood analysis devices, a laryngoscope, and a stethoscope. The illustrated embodiment includes an ultrasound scan device.

The probe unit connects to a docking assembly 501. This docking assembly connects physically and electrically to a hand held device, in this case an iPhone 503.

The entire assembly of FIG. 5 acts as a hand held ultrasound scan device.

The probe unit includes a transducer 505 which transmits and receives ultrasound pulses to and from a body to be scanned. Ultrasound pulses travel into the body and are reflected and refracted by features within the body, The echoes are received by the transducer and give rise to electrical received signals.

The transducer is driven by transmit/receive electronics 606. These electronics provide the appropriate electrical signals to drive the transducer, and receive the electrical signals returned from the transducer.

Position/orientation sensor 508 is provided. This provides information about the position/orientation of the probe unit.

In use, a user rotates the probe unit as required to sweep the ultrasound beam over the desired area, keeping linear displacement to a minimum.

The ultrasound transducer 505 transmits ultrasound pulses and receives reflected echoes form the features of the body being imaged. The corresponding electrical signals are passed to the receive electronics 506 which pass this data to the processor 507.

At the same time, data is received by the processor 507 from the position/orientation sensor 508, in this embodiment, a gyroscope. This data describes the rotation about the sensed axes of the probe unit. It may be the angular change in the position of the probe unit since the immediately previous transducer pulse, or the orientation of the probe unit in some defined frame of reference. One such frame of reference may be defined by nominating one transducer pulse, normally the first of a scan sequence, as the zero of orientation.

The sensor data and the received scan signals are received by probe processor 507. The sensor and received scan data are combined to form scanlines. A scanline is a dataset which comprises a sequential series of intensity values of the response signal combined with orientation information.

The scanlines are then passed to communications module 509 for transmission to the dock 501 via a communications channel.

Physical connection of the probe unit 502 to the dock assembly 501 is via probe connector 530. communications cable 510 and dock probe connector 511. The connectors may be fixed connections or they may be plug and socket connections. One connector of each type may be used.

In an embodiment, the connectors and the cable may be replaced by a wireless communications link, for example, Bluetooth (IEEE 802.15.x) or Wi-Fi (IEEE 802.11 a/b/g/n).

The communications channel is carried by this physical or wireless connection,

The dock assembly includes dock Communications module 512. This communicates with the probe communications module 509 via the communications channel to receive the scanline data. The communications link may use any suitable protocol. This may be a generic device to device protocol such as USB or RS-232. In a battery powered device such as this, power consumption should be minimised. Therefore, in a preferred embodiment, an internal communications protocol with low power consumption such as 8b10b is used

The dock assembly 501 includes a dock processor 513. This controls the communication with the probe unit 502.

The dock assembly is also connected to the iPhone 503 via dock device connector 531. This connection carries a communications channel which is supported by the iPhone. Conveniently it may be a generic device to device protocol such as USB.

The dock processor 513 and the dock communications module 612 receive and process the scanline data, converting the data stream to a format suitable for reception by the Phone 503. In a preferred embodiment this format is USB protocol.

The scanline data is passed to the iPhone. The iPhone has an iPhone processor which runs an ultrasound software application 515.

The ultrasound application is implemented using the third party software development kit (SDK) facilities provide by Apple, Inc, the makers of the iPhone, Makes of other suitable hand held devices also provide analogous capabilities.

The ultrasound application 515 receives the scanline data. The ultrasound application processes the data to produce an ultrasound scan image for display on the iPhone display 516,

The ultrasound application builds up the scan image by placing the brightness values of the scan lines into a display buffer in correct spatial orientation based on the position/orientation data associated with each scanline.

The display buffer contains the brightness values for the pixels of the iPhone display 516. Interpolation between scan line data values in the display buffer is performed in order to produce a smooth image. This interpolation assigns brightness values to the pixels for which no scanline data is available, by interpolating between the values of neighbouring pixels.

The hand held device includes a user interface 517. In the case of the preferred iPhone, this is a touch screen and associated software. The touch screen is the display screen 516.

In other embodiments other user input devices may be used including, but not limited to a scrollwheel, a push button and a voice command module.

Movement of the probe unit, as sensed by sensor 508 may be used for user input when the probe unit is not in a scanning mode,

The user interface 517 allows the user to control attributes of the display of the ultrasound scan image. These attributes are the same attributes as may be controlled for the display of images by a known dart based ultrasound scan unit. These include but are not limited to brightness, dynamic range, and image zoom.

The user interface also allows the user to annotate images in the same manner as can be done by known cart based units. This may include the application of callipers, measurements or text annotations.

A user may record voice to be associated with a scan image.

The user may associate patient and examination details with an image ore series of images, in the same way as may be done using known cart based ultrasound units.

The ultrasound application allows images to be stored in fixed or removable memory associated with the hand held processing device. These images may be retrieved for later display, or for download to other processing or storage devices such as a personal computer.

The ultrasound application controls the user interface to provide a control interface for the probe unit and the ultrasound scan process. All functions of the ultrasound scan device may be controlled.

Scans may be started and stopped. The scan depth may be set. The angle between successive triggerings of an ultrasound pulse to form a scanline may be set. The scan mode may be changed from B mode to M mode, or to any other mode supported by the probe unit.

The dock unit 501 may also include user input devices, in the illustrated embodiment, a scroll wheel 519 and a push button 520. Other suitable user input devices may be provided.

The user input devices on the dock assembly provide input to the dock processor 513.

The dock assembly further includes I/O ports 518 which may be audio input and output jacks.

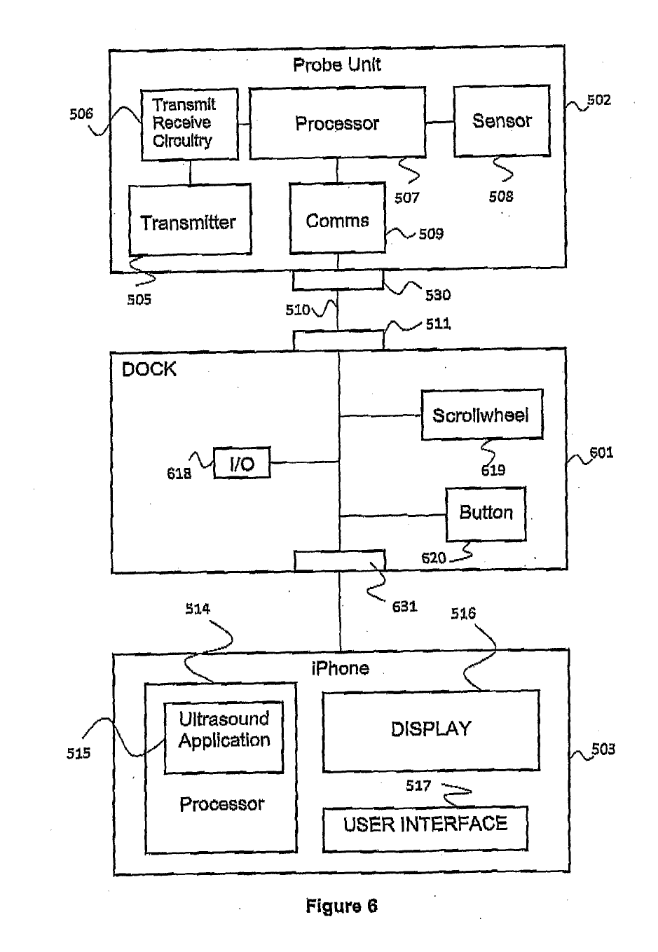

FIG. 6 shows a further embodiment of the invention. The probe unit 502 and the iPhone or PDA 503 are as for the previously described embodiment.

There is provided a dock assembly 801 which is physically as illustrated in FIG. 1 and FIG. 2. In this embodiment the dock assembly does not include a processor. User input devices are provided, These are a scroll wheel 619 and a push button 820. Other appropriate user input devices may be provided,

The electronic signals for the user input devices are transmitted to either or both of the probe unit processor 507 or the iPhone processor 514,

In a preferred embodiment, the probe unit processor monitors the dock assembly and returns the state of the inputs to the iPhone processor 514 via communications channel 510, which is carried unchanged through the dock assembly 601 to the iPhone processor.

In an alternative embodiment, the iPhone processor 514 receives the electronic signals directly from the user input devices 619, 620 via modified connector 631. This requires that the iPhone or PDA be capable of receiving direct inputs beyond those of the communications protocol (such as USB) which is in use.

The advantage of the embodiment of FIG. 6 is that the dock assembly is easier and cheaper to build. It increases the complexity of either the probe unit software or of the physical connector between the clock assembly and the iPhone.

In a further embodiment, the ultrasound application 515 provides only display and user input reception functionality. All processing is done by either dock assembly processor 513 or by probe unit processor 507. In an embodiment where no dock assembly processor is provided, this function is performed by the probe unit processor.

This processing results in a user interface display as pixel images. All interpolations, and display of such annotations as callipers, are performed before the image is sent to the iPhone for display.

In this embodiment, the iPhone receives a streaming video feed of the required display and returns the state of the user input devices such as the touchscreen.

The streaming video is received, and the user device information returned, by a protocol native to the hand held device, in this embodiment the USB protocol. The advantage of this approach is the extreme simplicity of the third party program, the ultrasound application 516, which runs on the hand held device. The disadvantage is the fact that the iPhone processor 514 may be underutilized, while the dock or probe unit processors may need to be of greater processing power to meet the demands of providing the video display.

In preferred embodiments, the iPhone remains useable as a telephone device while held in the dock assembly. All functions of the iPhone remain accessible, although use may be restricted whilst an ultrasound scan is actually in progress.

The iPhone or other device may be set into a mode which is provided as a standard function of the device which may be called “flight mode” or “aeroplane mode”, in which the telecommunications function of the device is disabled, but the remaining processing and display applications continue to be available.

In order for camera functionality to continue to be provided a camera lens must remain unobscured.

This may be achieved by careful choice of battery layout or geometry. The battery may be made of a shape, including a shape with an opening through the body of the battery, which allows the existing camera lens to be unobscured.

Alternatively, the dock assembly may include a camera sensor, able to be controlled by the usual camera control mechanism of the iPhone, which is on the outside of the dock assembly. This has the advantage that a superior camera to that provided by the iPhone may be implemented.

In a further embodiment, the dock processor 513 and the probe unit processor 507 are absent. Raw ultrasound data is transmitted to the hand held device, and all processing is performed by the ultrasound application 515 running on the hand held device processor 514.

Although the invention has been herein shown and described in what is conceived to be the most practical and preferred embodiment, it is recognised that departures can be made within the scope of the invention, which is not to be limited to the details described herein but is to be accorded the full scope of the appended claims so as to embrace any and all equivalent devices and apparatus.

1-18. (canceled)

19. A docking assembly which docks with a commercially available handheld data processing device of a type including a display, a processor and an I/O port, the docking assembly including a first connection which connects to a port of the handheld device;
a body which at least partially surrounds the handheld device to support and protect said device;
and a second connection which connects in use to a medical diagnostic scan probe unit said probe unit functioning to collect medical diagnostic data and transmit said data to the handheld processing device via the connection, the docking assembly being of a size and weight to be handheld when in use.

20. The docking assembly of claim 1 wherein the body has at least two portions which mate around the handheld device to support and protect said device.

21. The docking assembly of claim 20 wherein the two portions are connected by a hinge.

22. The docking assembly of claim 1 wherein at least part of the body is constructed of a deformable material such that the docking assembly is able to deform around the handheld device to secure the handheld device within the body.

23. The docking assembly of claim 1 wherein the docking assembly includes a secondary power source.

24. The docking assembly of claim 23 wherein the secondary power source is a battery.

25. The docking assembly of claim 24 wherein the battery forms a structural part of the docking assembly and supports and protects the handheld device.

26. The docking assembly of claim 1 wherein the first connection is a physical connector able to mate with a second physical connector which is an integral part of the handheld data processing device.

27. The docking assembly of claim 1 wherein the first connection is a wireless communication channel.

28. The docking assembly of claim 1 wherein the second connection is a cable fixedly attached to the probe unit and to the docking assembly.

29. A docking system comprising the docking assembly of claim 1 further including a software application running on the processor to process the medical diagnostic data and to display the information resulting from the processing of said data on the display, and a user interface which accepts user input via the handheld device, and uses the user input to control functions of the probe unit.

30. The docking system of claim 29 wherein the docking assembly further includes a supplementary user interface which allows a user to control at least some functions of the medical diagnostic scan probe unit.

31. A handheld processing device when programmed to control a medical diagnostic scan probe unit whilst supported and protected by a docking assembly to which the scan probe unit is connected.

32. A medical device scan probe unit adapted to be connected to a handheld docking assembly, said assembly adapted to support, protect and connect to a handheld processing device.

33. The docking assembly of claim 1 wherein the handheld device is a PDA device.

34. The docking assembly of claim 1 wherein the handheld device is a smartphone device.

35. The docking assembly of claim 1 wherein the handheld device is an iPhone.

36. The docking assembly of claim 1 wherein the medical diagnostic scan probe unit is an ultrasound transducer probe unit.
